(19) United States
(12) Patent Application Publication
(10) Pub. No.: US 2017/0116394 A1
(43) Pub. Date: Apr. 27, 2017

(54) METHOD AND SYSTEM FOR SHARING CONTENTS WITH REMOVABLE STORAGE

(71) Applicant: KT CORPORATION, Kyeonggi-do (KR)

(72) Inventors: JAE-SEOK JANG, Seoul (KR); SEOG-CHEON JEON, Seoul (KR); HYUNG-SIK KIM, Seoul (KR)

(73) Assignee: KT CORPORATION, Kyeonggi-do (KR)

(21) Appl. No.: 15/397,697

(22) Filed: Jan. 3, 2017

Related U.S. Application Data
(63) Continuation of application No. 12/645,358, filed on Dec. 22, 2009, now abandoned.
Application No. 12/645,358 is a continuation of application No. PCT/KR2008/003555, filed on Jun. 23, 2008.

(30) Foreign Application Priority Data
Jun. 28, 2007 (KR) 10-2007-0064151

(51) Int. Cl. G06F 21/10; H04L 9/08; H04L 29/06; H04L 9/14; H04L 9/30

(52) U.S. Cl. CPC G06F 21/10; H04L 9/14; H04L 9/30; H04L 63/0876; H04L 9/0822; H04L 63/083; H04L 63/06

(57) ABSTRACT

Disclosed is a content sharing method and system using an external memory. A method for transmitting encrypted contents to an external memory device list includes receiving a device list and public keys for devices, encrypting a domain key by using a public key to generate at least one device domain key, and transmitting the device domain key to the external memory. The method for performing encrypted contents further includes checking a public key of a device, extracting a device domain key corresponding to a public key checked by at least one device domain key stored in an external memory, decoding the extracted device domain key, decoding the encrypted contents by using the decoded device domain key, and performing the decoded encrypted contents. According to the present invention, since a single piece of contents stored in an external memory is reproducible by a plurality of devices, the existing problem of repeatedly settling the single piece of contents is solved and external memory resources are efficiently used.

### CROSS-REFERENCE TO RELATED APPLICATIONS

This application is a continuation application under 35 U.S.C. §365(c) of International Application No. PCT/KR2008/003555, filed Jun. 23, 2008, designating the United States. International Application No. PCT/KR2008/003555 was published in English as WO 2009/002059 A1 on Dec. 31, 2008. This application further claims for the benefit of the earlier filing dates under 35 U.S.C. §365(b) of Korean Patent Application No. 10-2007-0064151 filed Jun. 28, 2007. This application incorporates herein by reference the International Application No. PCT/KR2008/003555 including WO 2009/002059 A1 and the Korean Patent Application No. 10-2007-0064151 in their entirety.

### BACKGROUND

Field

The present invention relates to contents sharing method and system using an external memory. Particularly, the present invention relates to a method and system for using a single piece of contents by a plurality of devices by using an external memory.

Related Technology

As the Internet has been developed, the digital contents industry has also been greatly developed because the digital contents have been activated by means of the Internet. However, side effects have also been substantially generated because of it, for example, illegal reproduction or disallowed distribution of digital contents.

In order to eradicate the illegal reproduction and disallowed distribution, the digital rights management (DRM) method has been used.

The DRM method is a scheme for encrypting paid digital contents by using a predefined private key or a proper number of a device as an encryption key so that a user having received the paid digital contents may not distribute them illegally. The encrypted digital contents is used by one device having a proper number used as an encryption key, and is used for a predetermined number of times or for a predetermined period.

In addition, various devices having wired/wireless terminals that have been manufactured recently include various additional functions such as a photographing function, a music reproducing function, and an image reproducing function. Further, needs of sharing the contents including photos, video, and songs caused by the additional functions with another device have increased.

Attachable memories, so-called external memories, for sharing and exchanging various contents have been used, and various devices respectively have a slot for inserting an external memory.

However, the contents that are encrypted by the DRM method cannot be used by another device even though they are shared by using an external memory, and hence, a plurality of files encrypted by respective encryption keys for the contents to be used for a plurality of devices are to be stored in the external memory so that resources of the external memory is unnecessarily wasted and the meaning of sharing disappears.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a method and system for a plurality of devices to share a piece of contents encrypted by the DRM method by using an external memory.

One aspect of the invention provides a method of playing an encrypted content. The method comprises: connecting a content-storage device to a content-playing device for playing an encrypted content stored in the content-storage device, wherein the content-playing device is pre-registered for use in playing the particular content; retrieving, from the content-playing device, a unique identifier (or public key) of the content-playing device; decoding a content identifier (or domain key) also stored in the content-storage device, wherein decoding uses the unique identifier of the content-playing device and produces a content encryption key (or CEK); decrypting the encrypted content using the content encryption key; and playing the decrypted content in the content-playing device.

In the foregoing method, the content identifier may be decodable using one or more additional unique identifiers of content-playing devices that are also pre-registered for use in playing the particular content. The content identifier may be pre-encoded using a plurality of unique identifiers of content-playing devices that are pre-registered for use in playing the particular content, and wherein the content identifier may be decodable using any one of the plurality unique identifiers. The unique identifier may comprise a serial number of the content-playing device. Paying may comprise at least one of displaying a visual image on a screen of the content-playing device and playing a sound recording in the content-playing device.

The foregoing method may further comprise: registering the content-playing device with a content supplier, wherein registering may comprise providing the unique identifier of the content-playing device; and downloading the encrypted content into the content-storage device along with the content identifier, which may be pre-encoded for decoding using the unique identifier of the content-playing device. The method may further comprise: registering one or more additional content-playing devices with the content supplier, wherein registering may comprise providing unique identifiers of the one or more additional content-playing devices, wherein the content identifier downloaded along with the encrypted content may be pre-encoded for decoding using any one of the unique identifiers of the one or more additional content-playing devices. Decoding may further comprise: extracting a private key corresponding to the unique identifier of the content-playing device; and using the private key to produce the content encryption key. Decoding further may comprise: extracting the content encryption key from a right object stored also in the content-storage device.

Another aspect of the invention provides a method of providing an encrypted content for playing only in a plurality of pre-registered content-playing devices. The method comprises: receiving information about a plurality of content-playing devices that a user intends to use in playing a content, the information comprising a unique identifier of each of the plurality of content-playing devices; creating a content identifier that is decodable using any one of the unique identifiers of the plurality of content-playing devices, while not decodable using unique identifiers of any other content-playing devices; providing an encrypted version of the content that is decryptable using a content encryption key, which is to be produced by properly decoding of the content identifier; and supplying the encrypted version of the content along with the content identifier for downloading into a content-storage device such that the content is playable in any one of the plurality of content-playing devices.

In the foregoing method, a right object may be further supplied along with the encrypted version of the content, wherein the right object contains the content encryption key and provides the content encryption key upon proper decoding of the content identifier. The unique identifier of one of the plurality of content-playing devices may comprise a serial number of the content-playing device.

A still further aspect of the invention provides a content-storage device comprising: an encrypted content; a right object module comprising a content encryption key for use in decrypting the encrypted content; a content identifier decodable using any one of a plurality of pre-registered unique identifiers of content-playing devices, but using the plurality of pre-registered unique identifiers only, and wherein the right object is configured to provide the content encryption key upon proper decoding of the content identifier using one of the plurality of pre-registered unique identifiers. Each of the unique identifiers corresponds to a private key for use in decoding to the content identifier.

The content-storage device may further comprise: another encrypted content; another content identifier decodable using any one of a plurality of pre-registered unique identifiers of content-playing devices, but using the plurality of pre-registered unique identifiers only; and wherein the right object may be configured to provide the content encryption key upon proper decoding of the other content identifier using one of the plurality of pre-registered unique identifiers. The content-storage device may comprise a folder structure, wherein the right object module may be in the form of a folder, wherein the encrypted content and the content identifier are located in separate folders.

An exemplary embodiment of the present invention provides a method for performing encrypted contents of an inserted external memory by a device including: (a) checking a public key of the device, the public key being a proper number allocated to the device; (b) extracting a device domain key corresponding to the public key from at least one device domain key stored in the external memory, the device domain key being a contents identifier encrypted by the public key; (c) decoding the device domain key extracted in (b) by using the public key; and (d) decoding the contents stored in the external memory and performing the same by using the decoded device domain key.

Another embodiment of the present invention provides a method for transmitting encrypted contents from a wired/wireless terminal to an external memory including: (a) receiving a device list for performing the encrypted contents, and public keys for the respective devices included in the device list, the public keys being proper numbers allocated to the devices; (b) encrypting a domain key used as a contents identifier by using the public key to generate at least one device domain key; and (c) transmitting the at least one device domain key to the external memory.

Yet another embodiment of the present invention provides a contents sharing system in a system for supporting sharing of encrypted contents using an external memory, the system including a contents server for storing and managing the encrypted contents; an authentication managing server for managing a right object (RO) including a contents encryption key used for encrypting the contents; a device managing server managing a list of devices sharing the encrypted contents; and a public key managing server for authenticating the devices, and managing a public key used for extracting the contents encryption key from the RO.

According to an embodiment of the present invention, an external memory for providing encrypted contents to at least one of device includes: a contents storing module for storing encrypted contents; a right object (RO) storing module for storing RO including a contents encryption key for decoding the encrypted contents; and a domain key storing module for storing at least one device domain key used for extracting the contents encryption key from the RO.

### BRIEF DESCRIPTION OF THE DRAWINGS

FIG. 1 shows a configuration of a contents sharing system using an external memory according to an exemplary embodiment of the present invention.

FIG. 2 shows an inner configuration of an external memory according to an exemplary embodiment of the present invention

FIG. 3 shows an inner configuration of an external memory realized as a directory and folder type.

FIG. 4 shows a flowchart of a method for a wired/wireless terminal to transmit contents to an external memory according to an exemplary embodiment of the present invention.

FIG. 5 shows a flowchart of a method for executing the contents stored in an external memory of a device according to an exemplary embodiment of the present invention.

### DETAILED DESCRIPTION OF EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

In the specification, a module represents a unit for processing a predetermined function or an operation, and is realized by hardware, software or combination of hardware and software.

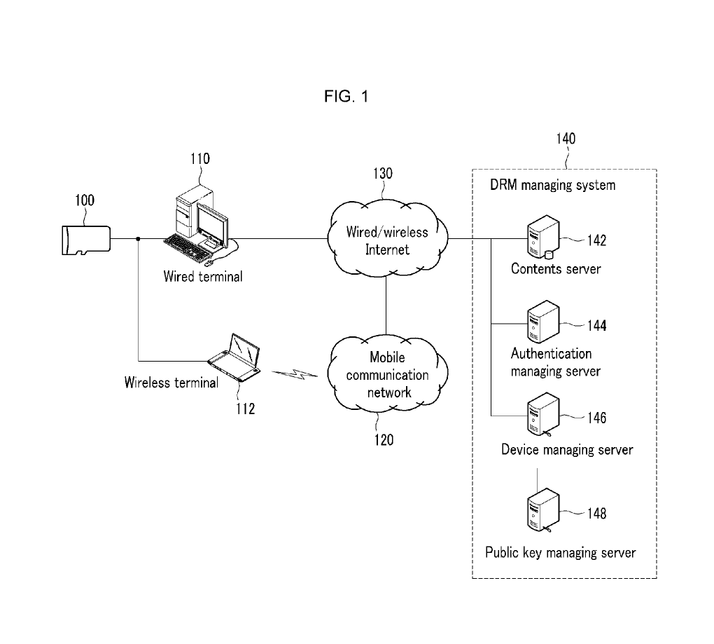

FIG. 1 shows a configuration of a contents sharing system using an external memory according to an exemplary embodiment of the present invention.

The contents sharing system includes an external memory 100, wired/wireless terminals 110 and 112, a wired/wireless Internet 130, and a DRM managing system 140. The contents sharing system further includes a mobile communication network 120 for connecting the wireless terminal 112 and the wired/wireless Internet 130.

The external memory 100 stores a plurality of contents and DRM information for the corresponding contents. Here, the DRM information includes a device list provided by the DRM managing system 140 and a domain key encrypted by a device public key.

Here, the device public key is a product proper number allocated to a device, and the domain key is a digital signature and identifies respective contents. Also, the domain key is supported to extract a contents encryption key for decoding contents from authentication information (also referred to as right object (RO)) provided by the DRM managing system 140. Accordingly, a single piece of contents has a common domain key.

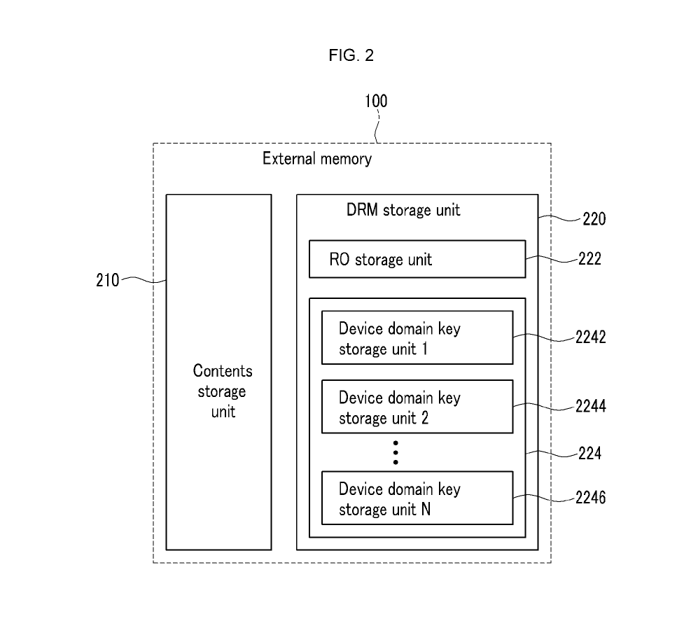

The configuration of the external memory 100 will be described with reference to FIG. 2.

The wired/wireless terminals 110 and 112 are classified as a wired terminal 110 directly connected to the wired/wireless Internet 130 and a wireless terminal 112 connected to the wired/wireless Internet 130 through the mobile communication network 120.

The wired terminal 110 includes a personal computer, a cable telephone, and a set-top box that are accessible to the wired/wireless Internet 130 through a cable, and the wireless terminal 112 includes a mobile terminal, a laptop computer, a PDA, and a PMP that include a communication module to access the wired/wireless Internet 130 through the mobile communication network 120 or directly access the wired/wireless Internet 130.

The wired/wireless terminals 110 and 112 have an external memory slot for inserting the external memory 100, encrypts the domain key transmitted by the DRM managing system 140 into a public key, transmits the public key to the external memory 100, encrypts the contents provided by the contents server 142, and stores the encrypted contents in the external memory 100.

The wired/wireless Internet 130 connects the wired terminal 110 and the wireless terminal 112 connected through the mobile communication network 120 with the DRM managing system 140.

The DRM managing system 140 manages registration information on the device for using the contents, transmits registered device information to the wired/wireless terminals 110 and 112, and authenticates the user, thereby providing various kinds of information for the contents sharing service. For this purpose, the DRM managing system 140 includes a contents server 142, an authentication managing server 144, a device managing server 146, and a public key managing server 148.

The contents server 142 stores and manages the contents that are transmitted to the wired/wireless terminals 110 and 112 through the wired/wireless Internet 130. Also, the contents server 142 encrypts the contents transmitted to the wired/wireless terminals 110 and 112 through the wired/wireless Internet 130 so as to manage the rights of the contents. In this instance, a contents encryption key (CEK) is used to encrypt the contents.

Here, the contents server 142 can be managed by an additional contents service provider, and the contents server 142 can be provided to a place other than that of the DRM managing system 140.

The authentication managing server 144 manages a right object (RO) including the CEK used for contents encryption.

The device managing server 146 manages information on the registered device. That is, the device managing server 146 stores and manages a list of devices and types of devices in order to use the contents stored in the external memory 100.

Also, the contents according to the exemplary embodiment of the present invention can be shared by a plurality of devices, and can also be shared by predetermined groups (e.g., company, post, and school department). When the contents are shared by the groups, the device managing server 146 stores and manages user information corresponding to the respective groups or information on the wired/wireless terminal.

The public key managing server 148 is connected to the device managing server 146, authenticates the user, wired/wireless terminal, or the device having requested to provide contents, and manages and provides a public key of the registered device. For this purpose, the public key managing server 148 can be connected to the manufacturer of the device.

Here, an additional input/output unit can be configured to be connected to the device managing server 146 and the public key managing server 148 so that device information, group information, and the public key stored in the device managing server 146 and the public key managing server 148 may be edited and corrected through the input/output unit.

Here, the contents server 142, the authentication managing server 144, the device managing server 146, and the public key managing server 148 can be realized as individual hardwired devices, or can be realized to be divided according to their functions in a single hardwired device.

FIG. 2 shows a block diagram of an inner configuration of an external memory according to an exemplary embodiment of the present invention.

The external memory 100 includes a contents storing module 210 for storing contents, and a DRM storing module 220 for storing encryption and decoding data.

The contents storing module 210 stores encrypted contents provided by the contents server 142 through the wired/wireless Internet 130.

The DRM storing module 220 stores data for decoding the encrypted contents, and includes an RO storing module 222 and a domain key storing module 224.

The RO storing module 222 stores an RO including a CEK for decoding the encrypted contents. Here, the CEK included in the RO is decoded by using a domain key, and for this purpose, the RO storing module 222 receives a domain key on the device for operating the contents from the domain key storing module 224.

The domain key storing module 224 stores a domain key for each device. That is, when the wired/wireless terminals 110 and 112 encrypt the domain key by using the public keys of the respective devices registered in the DRM managing system 140, the encrypted domain key is stored in the domain key storing module 224 of the external memory 100.

In a contents sharing system having N registered devices, the domain key storing module 224 of the external memory 100 includes N device domain key storing modules from the first device domain key storing module 2242 to the N-th device domain key storing module 2246.

The external memory 100 can be realized by hardware and software. In the case of realization by software, the contents storing module 210, the DRM storing module 220, the RO storing module 220, and the device domain key storing modules (2242 to 2246) can be realized in the folder type with the directory structure.

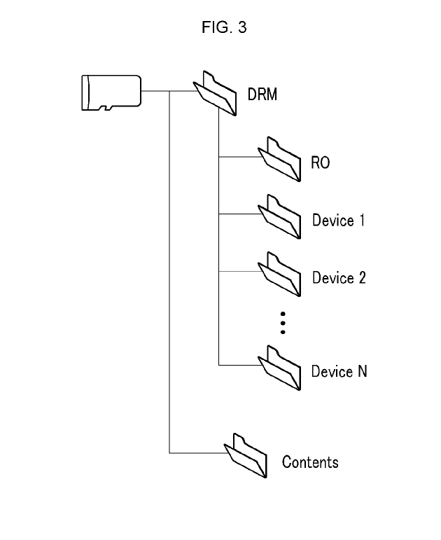

FIG. 3 shows an inner configuration of an external memory realized in the directory and the folder type.

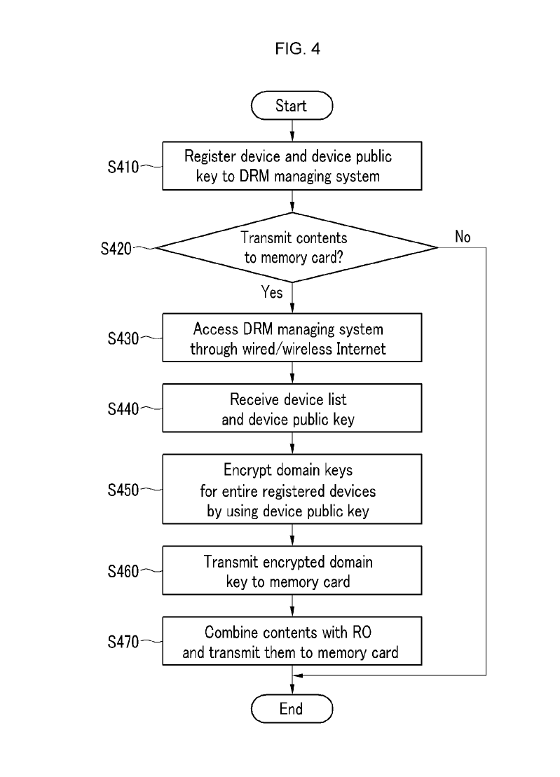

FIG. 4 shows a flowchart of a method for a wired/wireless terminal to transmit contents to an external memory according to an exemplary embodiment of the present invention.

Before the wired/wireless terminals 110 and 112 in the contents sharing system transmit the contents provided by the DRM managing system 140 to the external memory 100, the user must register a device list for desired contents to the DRM managing system 140. In this instance, when the device list is registered to the DRM managing system 140, public keys allocated to the respective devices are also input.

The registered device list is transmitted to the device managing server 146 and is then stored, and the input public keys are stored in the public key managing server 148 (S410).

When the device list and the public keys of the devices are stored in the DRM managing system 140 and a contents transmission request for using contents from the user is input to the wired/wireless terminals 110 and 112 (S420), the input contents transmission request is transmitted to the DRM managing system 140 through the wired/wireless Internet 130. Through the above-noted process, the wired/wireless terminals 110 and 112 are connected to the DRM managing system 140 (S430).

The wired/wireless terminals 110 and 112 connected to the DRM managing system 140 receive the registered device list and the public keys of the respective devices from the device managing server 146 of the DRM managing system 140 (S440).

When receiving the device list and the public keys of the devices, the wired/wireless terminals 110 and 112 encrypt the domain keys of the registered devices by using respective public keys (S450), and transmit the encrypted domain keys to the external memory 100. The encrypted domain keys transmitted to the external memory 100 are stored in the domain key storing module 224 (S460).

The wired/wireless terminals 110 and 112 receive the contents from the contents server 142 of the DRM managing system 140. In this instance, the contents transmitted by the contents server 142 are encrypted by the CEK. Also, the wired/wireless terminals 110 and 112 receive an RO for decoding the encrypted contents from the authentication managing server 144 of the DRM managing system 140, transmit the received contents and the RO to the external memory 100, and store the same therein. In this instance, the contents transmitted to the external memory 100 are stored in the contents storing module 210, and the RO is stored in the RO storing module 222 (S470).

Here, the receiving of the contents and the RO according to S470 can be performed simultaneously with S440.

Through the above-noted process, the wired/wireless terminals 110 and 120 transmit the encrypted contents and the decoding data on the encrypted contents to the external memory 100.

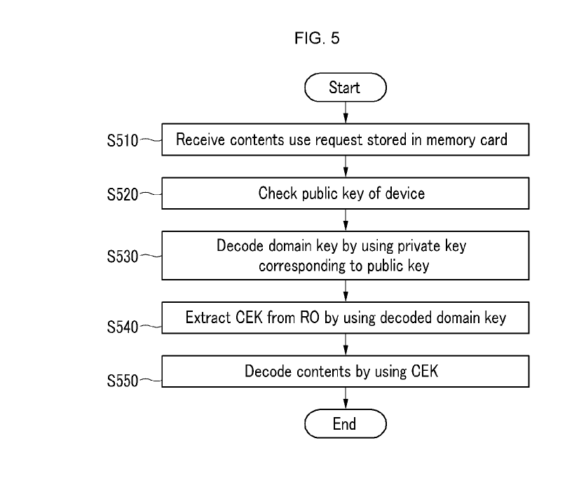

FIG. 5 shows a flowchart of a method for executing the contents stored in an external memory of a device according to an exemplary embodiment of the present invention.

According to the description with reference to FIG. 4, the external memory 100 storing the contents and the decoding data can be inserted into various devices.

When a request for using the stored contents is provided by the user to the device into which the external memory 100 is inserted (S510), the device 100 checks the public key of the device 100 (S520).

When the public key is checked, the device 100 checks the device domain key storing module that corresponds to the domain key storing module 224 from the domain key storing module 224 of the external memory 100, and extracts the domain key stored in the checked device domain key storing module. The device 100 decodes the extracted domain key by using the public key checked in S520.

Here, it is desirable to use the asymmetric key encryption method in order to improve security when decoding the domain key by using the public key. Accordingly, the external memory 100 extracts the private key that corresponds to the public key, and decodes the domain key by using the extracted private key (S530).

The device calls an RO from the RO storing module 222. When the RO is called, the devices extracts a CEK from the RO (S540) by using the domain key decoded through S530, and decodes the contents by using the extracted CEK. The decoded contents are reproduced by the corresponding device (S550).

Therefore, a single piece of contents stored in the external memory is reproducible by a plurality of devices.

The method for executing a single piece of contents stored in the external memory by a plurality of devices has been described, and it is also possible to share the contents stored in the external memory or a shared storage medium among members of a predetermined specific group. In this instance, a method for performing the encryption and decoding method by using a proper number allocated to each member may be used, rather than the method for performing the encryption and decoding method by using the public key. It is also possible to add a process of receiving a proper number from the user when performing the encryption and decoding method using the proper number allocated to the member.

Further, it is possible to set a validity time for the contents stored and shared by the external memory and a time for terminating the sharing of contents when the validity time expires.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplified embodiment of the present invention, a single piece of contents stored in the external memory is reproducible by a plurality of devices to thus solve the conventional problem in which a contents user must repeatedly pay in order to perform a single piece of contents in a plurality of devices.

Further, in order to perform the same contents in a plurality of devices, the same contents that are encrypted by respective encryption keys are stored in a plurality of external memories to thereby solve the existing problem of wasting the resources of the external memory and to efficiently use the external memory resources.

What is claimed is:

1. A method of playing an encrypted content, the method comprising:
connecting a content-storage device to a content-playing device for playing an encrypted content stored in the content-storage device, wherein the content-playing device is pre-registered for use in playing the particular content;
retrieving, from the content-playing device, a unique identifier of the content-playing device;
decoding a content identifier also stored in the content-storage device, wherein decoding uses the unique identifier of the content-playing device and produces a content encryption key;
decrypting the encrypted content using the content encryption key; and
playing the decrypted content in the content-playing device.

2. The method of claim 1, wherein the content identifier is decodable using one or more additional unique identifiers of content-playing devices that are also pre-registered for use in playing the particular content.

3. The method of claim 1, wherein the content identifier is pre-encoded using a plurality of unique identifiers of content-playing devices that are pre-registered for use in playing the particular content, and wherein the content identifier is decodable using any one of the plurality unique identifiers.

4. The method of claim 1, wherein the unique identifier comprises a serial number of the content-playing device.

5. The method of claim 1, wherein playing comprises at least one of displaying a visual image on a screen of the content-playing device and playing a sound recording in the content-playing device.

6. The method of claim 1, further comprising:
registering the content-playing device with a content supplier, wherein registering comprises providing the unique identifier of the content-playing device; and
downloading the encrypted content into the content-storage device along with the content identifier, which is pre-encoded using the unique identifier of the content-playing device.

7. The method of claim 6, further comprising:
registering one or more additional content-playing devices with the content supplier, wherein registering comprises providing unique identifiers of the one or more additional content-playing devices, wherein the content identifier downloaded along with the encrypted content is pre-encoded for decoding using any one of the unique identifiers of the one or more additional content-playing devices.

8. The method of claim 1, wherein decoding further comprises:
extracting a private key corresponding to the unique identifier of the content-playing device; and
using the private key to produce the content encryption key.

9. The method of claim 1, wherein decoding further comprises:
extracting the content encryption key from a right object stored also in the content-storage device.

10. A method of providing an encrypted content for playing only in a plurality of pre-registered content-playing devices, the method comprising:
receiving information about a plurality of content-playing devices that a user intends to use in playing a content, the information comprising a unique identifier of each of the plurality of content-playing devices;
creating a content identifier that is decodable using any one of the unique identifiers of the plurality of content-playing devices, while not decodable using unique identifiers of any other content-playing devices;
providing an encrypted version of the content that is decryptable using a content encryption key, which is to be produced by properly decoding of the content identifier; and
supplying the encrypted version of the content along with the content identifier for downloading into a content-storage device such that the content is playable in any one of the plurality of content-playing devices.

11. The method of claim 10, wherein a right object is further supplied along with the encrypted version of the content, wherein the right object contains the content encryption key and provides the content encryption key upon proper decoding of the content identifier.

12. The method of claim 10, wherein the unique identifier of one of the plurality of content-playing devices comprises a serial number of the content-playing device.

13. A content-storage device comprising:
an encrypted content;
a right object module comprising a content encryption key for use in decrypting the encrypted content;
a content identifier decodable using any one of a plurality of pre-registered unique identifiers of content-playing devices, but using the plurality of pre-registered unique identifiers only, and
wherein the right object is configured to provide the content encryption key upon proper decoding of the content identifier using one of the plurality of pre-registered unique identifiers.

14. The content-storage device of claim 13, wherein each of the unique identifiers corresponds to a private key for use in decoding to the content identifier.

15. The content-storage device of claim 13, further comprising:
another encrypted content;
another content identifier decodable using any one of a plurality of pre-registered unique identifiers of content-playing devices, but using the plurality of pre-registered unique identifiers only; and
wherein the right object is configured to provide the content encryption key upon proper decoding of the other content identifier using one of the plurality of pre-registered unique identifiers.

16. The content-storage device of claim 15, wherein the content-storage device comprises a folder structure, wherein the right object module is in the form of a folder, wherein the encrypted content and the content identifier are located in separate folders.
